(19) United States
(12) Patent Application Publication
(10) Pub. No.: US 2025/0116540 A1
(43) Pub. Date: Apr. 10, 2025

(54) TEMPERATURE-PRESSURE SENSOR

(71) Applicant: WUHAN FINEMEMS INC., Wuhan (CN)

(72) Inventors: Xiaoping WANG, Wuhan (CN); Wan CAO, Wuhan (CN); Lin WU, Wuhan (CN); Shihao LIANG, Wuhan (CN); Peibao WU, Wuhan (CN); Hao WANG, Wuhan (CN); Xiuping ZHAO, Wuhan (CN)

(73) Assignee: WUHAN FINEMEMS INC., Wuhan (CN)

(21) Appl. No.: 18/982,193

(22) Filed: Dec. 16, 2024

Related U.S. Application Data
(63) Continuation of application No. PCT/CN2022/122015, filed on Sep. 28, 2022.

(30) Foreign Application Priority Data
Jun. 22, 2022 (CN) 202210709230.X

(51) Int. Cl. G01D 21/02; G01D 11/24; G01K 7/00; G01L 9/06

(52) U.S. Cl. CPC G01D 21/02; G01D 11/245; G01K 7/00; G01L 9/06

(57) ABSTRACT

A temperature-pressure sensor includes a shell, a pressure sensitive component provided in the shell and a temperature sensitive component provided in the lower cavity. The shell is provided with a fluid inlet. The pressure sensitive component includes a ceramic plate laterally extended. The temperature sensitive component includes a temperature sensor, and two connection ends of the temperature sensor are respectively electrically connected to the circuit board through an elastic connection body, a conductive pin and a conductor. The conductive pin is respectively correspondingly penetrated through two via holes opened on the ceramic plate, and a gap between the conductive pin and the corresponding via hole is sealed by a seal body made of glass material; and the fluid inlet is communicated with the lower cavity.

### CROSS-REFERENCE TO RELATED APPLICATIONS

The present application is a continuation application of International Application No. PCT/CN2022/122015, filed on Sep. 28, 2022, which claims priority to Chinese Patent Application No. 202210709230.X, filed on Jun. 22, 2022. The disclosures of the above-mentioned applications are incorporated herein by reference in their entireties.

### TECHNICAL FIELD

The present application relates to the technical field of sensors, and in particular to a temperature-pressure sensor.

### BACKGROUND

The statements in this section only provide background information related to the present application and may not constitute prior art.

The pressure sensitive element is divided into strain type, piezoresistive type, capacitive type, resistance strain gauge type and other types according to different principles. Among them, the piezoresistive pressure sensor is usually constructed by using the piezoresistive effect of single crystal silicon, which uses a single crystal silicon wafer as an elastic element, and uses the process of integrated circuits on the single crystal silicon diaphragm to diffuse a group of equal value resistors in a specific direction of the single crystal silicon. The resistors are connected into a bridge circuit, and the single crystal silicon wafer is placed in the sensor cavity. When the pressure changes, the single crystal silicon generates strain, so that the strain resistor directly diffused on the single crystal silicon generates a change proportional to the measured pressure, and the corresponding voltage output signal is obtained by the bridge circuit.

The piezoresistive pressure sensor usually uses metal substrates, which are usually sealed with sealants to the metal pins used for conduction. Due to the difference in thermal expansion coefficients, this type of pressure sensor cannot directly mount micro-electro-mechanical system (MEMS) chips on the metal substrate, so that the chip needs to be attached to an additional intermediate transition layer. In addition, due to the characteristics of the adhesive glue, it is also easy to cause unstable measurement signal output; or the metal-glass sealing is used. In this case, the glass is required to match the thermal expansion coefficient of the metal substrate, the glass and the metal substrate need to be cleaned to avoid leakage or bursting, and annealing is also required to reduce stress.

There are also a few piezoresistive pressure sensors that use ceramic materials as substrates. For example, Chinese Patent Application Publication CN112611504A discloses a combined type temperature-pressure sensor, including a ceramic member, a circuit board, an insulating seat and a temperature sensitive element. The circuit board is installed on the upper end of the ceramic member, the pressure sensitive element is installed on the upper surface of the ceramic member and electrically connected to the circuit board; the temperature sensitive element is provided on the insulating seat and is electrically connected to the circuit board through a conductive spring and a conductive element (such as a metal probe). In this case, when sealing the conductive element passing through the ceramic substrate, it is necessary to first metalize the via hole, that is, first plate it with Mo—Mn alloy, then plate a layer of metal Ni, and braze it with Au—Cu alloy solder to achieve the transition and adaptation of the coefficient of thermal expansion (CTE). Therefore, this process is very complicated and the cost is high.

The problem in the above technology is: for the temperature-pressure sensor, sealing the via hole on the metal substrate with sealant usually leads to insufficient sealing strength and poor durability; when using the metal glass sealing process, the process is more complicated and the sealing quality is not high; and when using the ceramic substrate, the necessary via hole metalization process makes the process more complicated and the cost higher.

### SUMMARY

In view of the shortcomings of the related art, the present application provides a temperature-pressure sensor, which can achieve high-quality sealing between a ceramic substrate and a conductive element without using a metallization process.

To achieve the above purpose, the present application provides a temperature-pressure sensor, including:
a shell provided with a fluid inlet;
a pressure sensitive component provided in the shell and including: a ceramic plate laterally extended and configured to separate an inner cavity of the shell into an upper cavity and a lower cavity longitudinally opposite to the upper cavity, a pressure core provided in the upper cavity and fixed on the ceramic plate, and a circuit board provided in the upper cavity and fixed on the ceramic plate; where the ceramic plate is provided with a hole channel communicated with the upper cavity and the lower cavity, and a pressure sensing surface of the pressure core is configured to seal a corresponding end of the hole channel; and
a temperature sensitive component provided in the lower cavity and including a temperature sensor, where two connection ends of the temperature sensor are respectively electrically connected to the circuit board through an elastic connection body, a conductive pin and a conductor; the conductive pin is respectively correspondingly penetrated through two via holes opened on the ceramic plate, and a gap between the conductive pin and the corresponding via hole is sealed by a seal body made of glass material; and the fluid inlet is communicated with the lower cavity.

In an embodiment, the temperature sensitive component further includes a mounting seat made of insulating material, and a middle part of the elastic connection body is embedded in the mounting seat; one end of the elastic connection body away from the fluid inlet is configured to extend approximately laterally to form an abutting portion abutted against the conductive pin; and one end of the elastic connection body towards the fluid inlet is formed with a vertical portion, and the vertical portion is fixed and electrically connected to a corresponding connection end.

In an embodiment, the mounting seat includes a disk body laterally extended and a plate body, and one end of the plate body away from the fluid inlet is connected to the disk body; and two vertical portions of the elastic connection body are provided at intervals along a width direction of the disk body, an extension portion longitudinally extended is fixed to one end of the plate body close to the fluid inlet, and the two vertical portions are respectively provided on opposite sides of the extension portion and configured to laterally approach or abut against the extension portion.

In an embodiment, the extension portion is configured to approach or abut against the temperature sensor towards one side of the fluid inlet, and the two connection ends are respectively provided on opposite sides of the extension portion and configured to laterally approach or abut against the extension portion.

In an embodiment, a protective sleeve is fixed in the fluid inlet, one end of the mounting seat close to the fluid inlet is configured to extend into the protective sleeve, and a pressure introduction gap communicated with the lower cavity is left among an inner wall of the fluid inlet, the protective sleeve and the mounting seat; and the pressure introduction gap includes: a first pressure introduction gap between the protective sleeve and the fluid inlet, and/or a second pressure introduction gap between the protective sleeve and the mounting seat.

In an embodiment, two sides of the plate body in a thickness direction are recessed inward to form a positioning groove laterally extended, and lateral opposite sides of an inner wall of the protective sleeve are configured to protrude outward to form a positioning convex ridge correspondingly abutted against two positioning grooves.

In an embodiment, the shell includes a first shell and a second shell longitudinally abutted with the first shell and provided on one side of the first shell away from the fluid inlet; a second positioning step is provided on one side of the second shell away from the fluid inlet; one end of the first shell away from the fluid inlet is configured to extend laterally inward to form a holding and pressing portion; and one side of the holding and pressing portion towards the fluid inlet is held and pressed on a step surface of the second positioning step.

In an embodiment, a plurality of positioning concave portions longitudinally penetrated are provided at intervals on a periphery of the ceramic plate, a periphery of one end of the second shell close to the fluid inlet is configured to protrude towards one side of the fluid inlet to form a plurality of first positioning convex portions, and each of the first positioning convex portions is configured protrude into one of the positioning concave portions towards one side of the fluid inlet.

In an embodiment, an inner wall of the first shell is configured to protrude inward to form a plurality of second positioning convex portions; and a thickness direction of the ceramic plate is in a longitudinal direction, a thickness of the ceramic plate is greater than a longitudinal length of the first positioning convex portion, and the second positioning convex portion is configured to extend into one of the positioning concave portions.

In an embodiment, a stopping surface is formed on the inner wall of the first shell towards the second shell, a first positioning step is formed on one end of the second shell towards the first shell, and the first positioning step and the second positioning step are respectively abutted against the ceramic plate on both longitudinal sides; and a first sealing groove is provided on the stopping surface, and a first sealing ring is provided in the first sealing groove.

In an embodiment, a plug-in connector for electrical connection is integrally connected to one end of the second shell away from the first shell; a pressure guiding hole for introducing a reference pressure medium into the lower cavity is provided on the second shell, the pressure guiding hole is configured to extend longitudinally, and one end of the pressure guiding hole away from the lower cavity is configured to extend into the plug-in connector; and one end of the pin is electrically connected to the circuit board, and another end of the pin is configured to sealingly pass through the second shell and extend into the plug-in connector.

In an embodiment, the circuit board includes a first plate body, a second plate body formed by vertically bending a lateral end of the first plate body towards a side away from the fluid inlet, a third plate body formed by vertically bending an end of the second plate body away from the first plate body towards another lateral end of the first plate body, a fourth plate body formed by vertically bending another end of the third plate body away from the second plate body towards a side away from the first plate body, and a fifth plate body formed by vertically bending an end of the fourth plate body away from the first plate body towards the other lateral end of the first plate body; and the first plate body is fixed to an end face of the ceramic plate away from the fluid inlet, and the first plate body is opened with a mounting window for the pressure core to pass longitudinally.

In an embodiment, a lateral end of the first plate body is configured to extend laterally outward to form a lateral extension portion, and the lateral extension portion is configured to pass through the shell and vertically bend towards one side away from the fluid inlet to form a longitudinal extension portion.

In an embodiment, the conductive pin includes a rod portion longitudinally extended and a cap portion formed by enlarging one end of the rod portion close to the fluid inlet, one side of the cap portion away from the fluid inlet is abutted against the ceramic plate, and an end of the rod portion away from the cap portion is electrically connected to the circuit board through the conductor.

In an embodiment, a frame longitudinally extended is fixed to an end face of the first plate body away from the fluid inlet, an end of the conductive pin away from the fluid inlet and the pressure core are provided in the frame, and the frame is filled with sealant; and the third plate body is configured to cover the frame from one side of the frame away from the fluid inlet.

The present application provides a temperature-pressure sensor, the pressure core is provided on the ceramic plate. Since the silicon substrate of the silicon piezoresistive pressure sensitive element has a CTE relatively close to that of the ceramic plate, the durability is greater. In addition, since the glass material has a CTE relatively close to that of the ceramic and has strong chemical affinity and good bonding performance, the manufacturing process is simplified and the manufacturing cost is reduced.

### BRIEF DESCRIPTION OF THE DRAWINGS

FIG. 1 is a stereoscopic view of a temperature-pressure sensor of the present application.

FIG. 2 is an exploded view of the temperature-pressure sensor of the present application.

FIG. 3 is a top view of the temperature-pressure sensor of the present application.

FIG. 4 is a stereoscopic exploded view of the temperature-pressure sensor of the present application along A-A shown in FIG. 3.

FIG. 5 is a left view of the temperature-pressure sensor of the present application.

FIG. 6 is a cross-sectional view of the temperature-pressure sensor of the present application along B-B shown in FIG. 5.

FIG. 7 is a stereoscopic cross-sectional view of the temperature-pressure sensor of the present application along B-B shown in FIG. 5.

FIG. 8 is a rear view of the temperature-pressure sensor of the present application.

FIG. 9 is a cross-sectional view of the temperature-pressure sensor of the present application along C-C shown in FIG. 8.

FIG. 10 is a stereoscopic view of a ceramic plate of the present application.

FIG. 11 is a stereoscopic view of a partial structure of a pressure sensitive component of the present application.

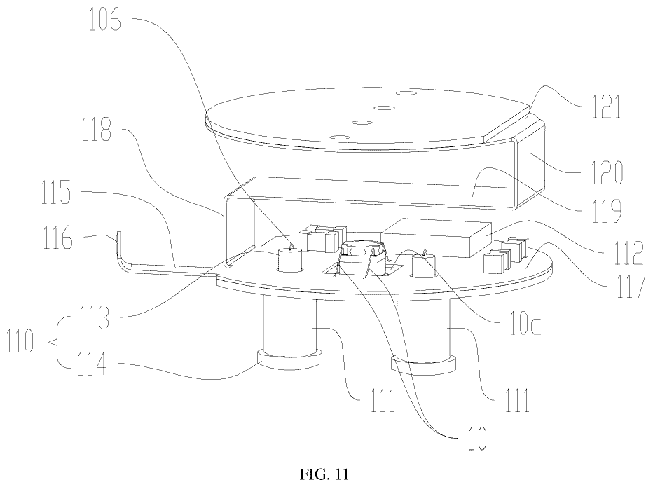

FIG. 12 is a stereoscopic view of a temperature sensitive component of the present application.

FIG. 13 is a right side view of the temperature sensitive component of the present application.

### DETAILED DESCRIPTION OF THE EMBODIMENTS

The technical solution of the present application will be described clearly and in detail below with reference to the accompanying drawings. The following embodiments are exemplary and are only used to explain the present application, and cannot be interpreted as limiting the present application. In the following description, the same mark is used to represent the same or equivalent elements, and repeated descriptions are omitted.

In the description of the present application, it should be understood that the terms “upper”, “lower”, “inner”, “outer”, “left”, “right” and the like indicate the orientation or position relationship based on the orientation or position relationship shown in the accompanying drawings, or the orientation or position relationship in which the application product is usually placed when used, or the orientation or position relationship commonly understood by those skilled in the art, which is only for the convenience of describing the present application and simplifying the description, rather than indicating or implying that the device or element referred to must have a specific orientation, be constructed and operated in a specific orientation, and therefore cannot be understood as limiting the present application.

In addition, the terms “installed”, “connected” and “communicated” should be understood in a broad sense, for example, it can be a fixed connection, a detachable connection, or an integral connection; it can be a mechanical connection or an electrical connection; it can be directly connected or indirectly connected through an intermediate medium, or it can be communicated between two components. For those skilled in the art, the specific meanings of the above terms in the present application can be understood according to the specific circumstances.

It should also be further understood that the term “and/or” used in the present application specification and the corresponding claims refers to any combination of one or more of the listed items and all possible combinations.

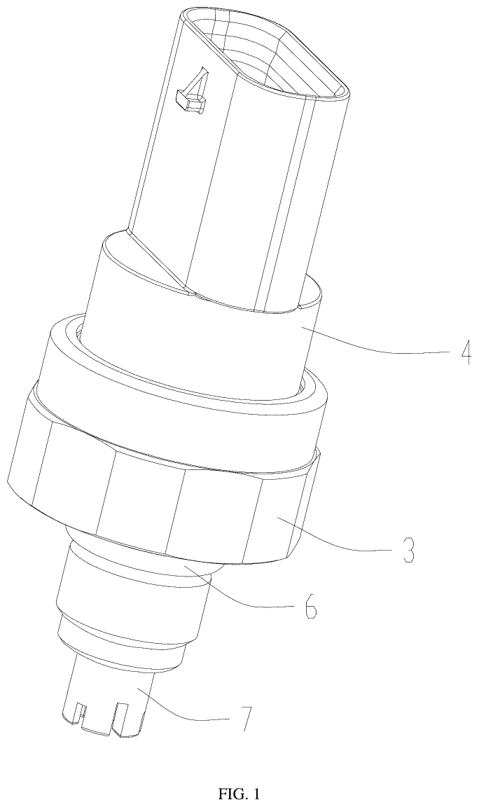

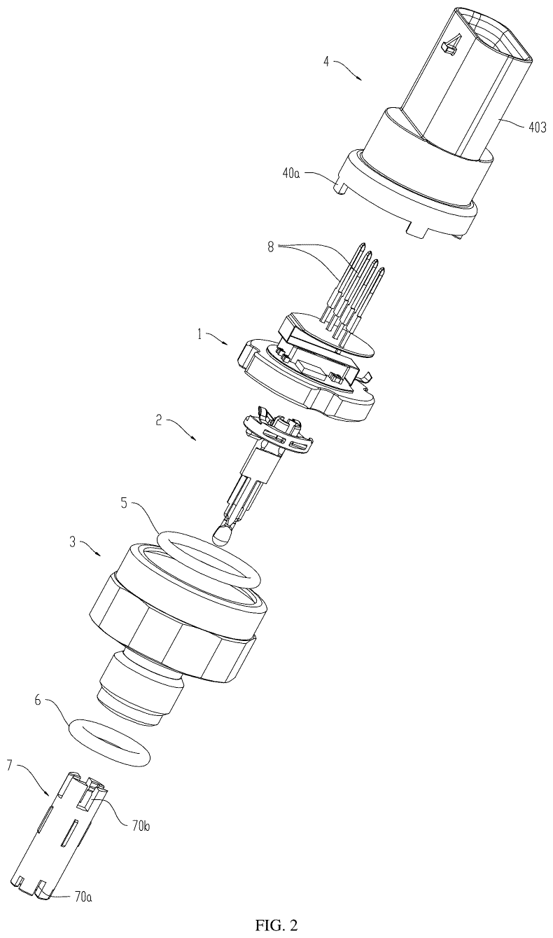

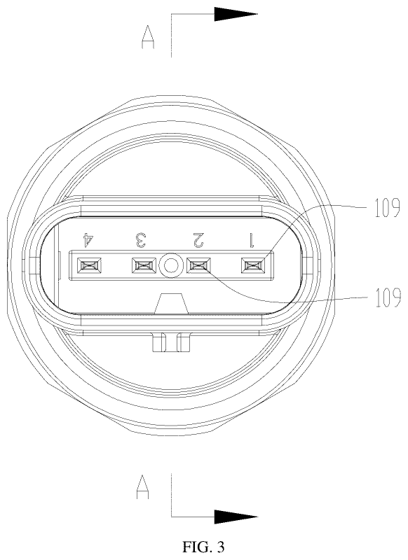

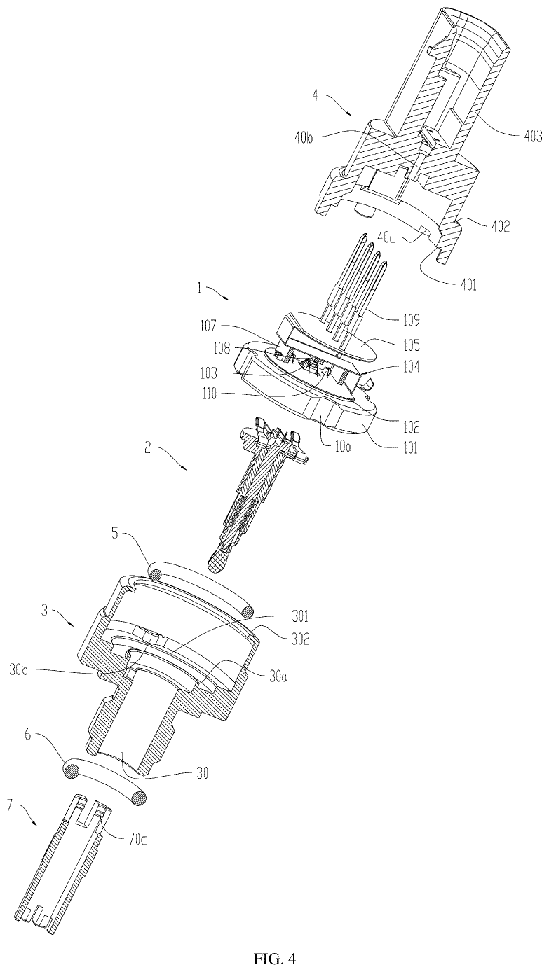

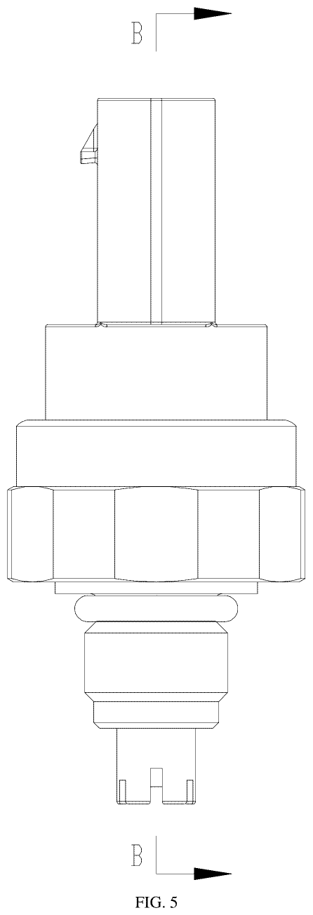

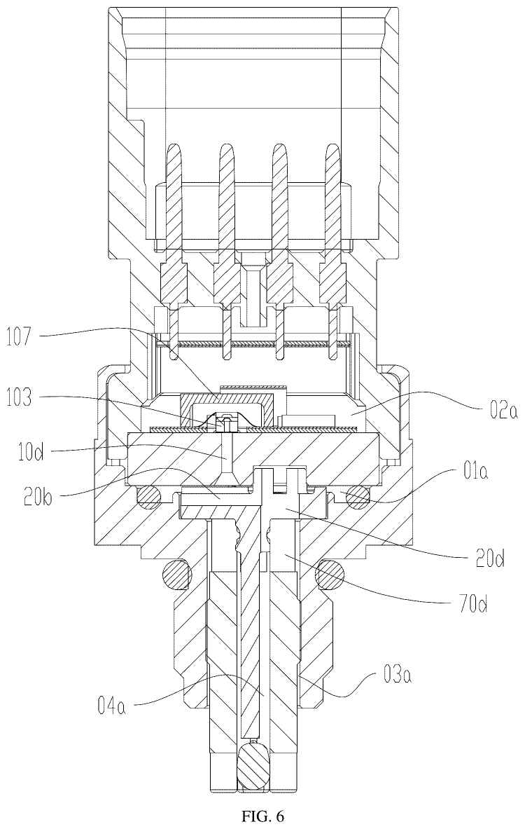

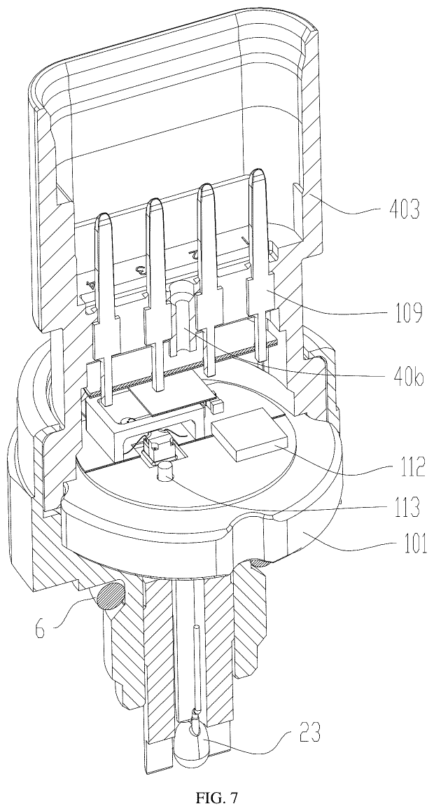

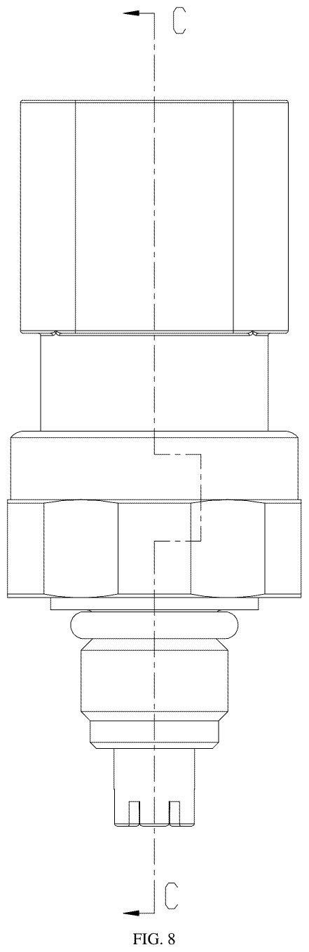

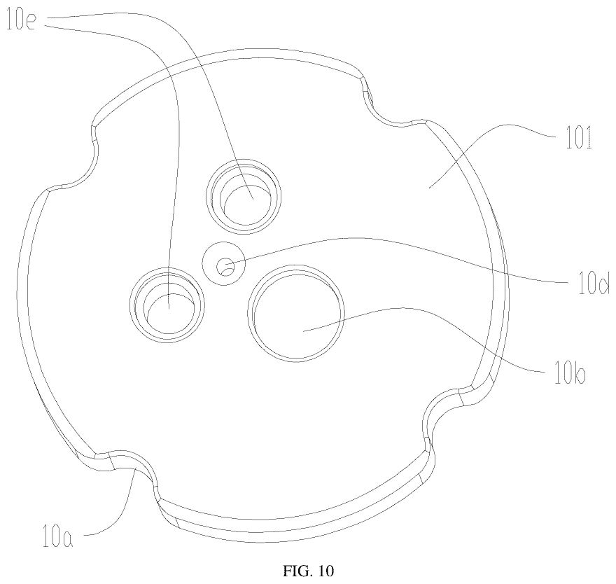

As shown in FIGS. 1 to 10, in an embodiment of the present application, the temperature-pressure sensor includes a shell, a pressure sensitive component 1 and a temperature sensitive component 2.

A fluid inlet 30 is provided at the lower end of the shell. The pressure sensitive component 1 is provided in the shell and includes a ceramic plate 101, a pressure core 103 and a circuit board 104. The ceramic plate 101 is configured to extend laterally and separate the inner cavity of the shell into an upper cavity 02a and a lower cavity 01a longitudinally opposite to the upper cavity 02a. A hole channel 10d is provided on the ceramic plate 101 and is communicated with the upper cavity 02a and the lower cavity 01a. The pressure core 103 is provided in the upper cavity 02a, and the pressure sensing surface of the pressure core 103 is blocked at a corresponding end of the hole channel 10d. The circuit board 104 is provided in the upper cavity 02a and fixed on the ceramic plate 101. The pressure core 103 is electrically connected to the circuit board 104 through wires 10.

The temperature sensitive component 2 is provided in the lower cavity 01a, and includes a temperature sensor 23. The temperature sensor 23 is provided with two connection ends 22, each of which is electrically connected to the circuit board 104 through an elastic connection body 21, a conductive pin 110 and a conductor 106 in turn. The two conductive pins 110 are respectively penetrated through two via holes 10e opened on the ceramic plate 101. The gap between the conductive pin 110 and the corresponding via hole 10e is sealed by a seal body 111 made of glass material. The fluid inlet 30 is communicated with the lower cavity 01a. In an embodiment, the pressure core 103 can be a silicon piezoresistive pressure sensitive element. In other embodiments, it can also be other suitable known pressure sensitive elements.

In the temperature-pressure sensor, the pressure core 103 is provided on the ceramic plate 101. Since the silicon substrate of the silicon piezoresistive pressure sensitive element has a coefficient of thermal expansion (CTE) relatively close to that of the ceramic plate 101, the durability is relatively strong. Moreover, since the glass material has a CTE relatively close to that of the ceramic, and has a strong chemical affinity and good bonding performance, the seal is not easy to fail. When pressing the conductive pin 110 at a constant pressure using a press machine, small cracks begin to form on the upper surface of the glass seal body until 750 MPa (calculated based on the cross section of the conductive pin 110). As the plastic deformation of the conductive pin 110 increases, the small cracks do not expand when the pressure increases to 1250 MPa. In addition, compared with the complex process and high cost of metallized holes, the present application also greatly reduces the manufacturing cost and simplifies the manufacturing process.

In other embodiments, the temperature sensitive component 2 may also include a mounting seat 20 made of the insulating material. The middle part of the elastic connection body 21 is embedded in the mounting seat 20. The upper end of the elastic connection body 21 is configured to extend approximately laterally to form an abutting portion 212. The abutting portion 212 is abutted upward against the lower end of the conductive pin 110. The lower end of the elastic connection body 21 is formed with a vertical portion 211, and the vertical portion 211 is fixed and electrically connected to the corresponding connection end 22. In other embodiments, the upper end of the elastic connection body 21 may be slightly tilted upward to form a better electrical connection with the lower end of the conductive pin 110.

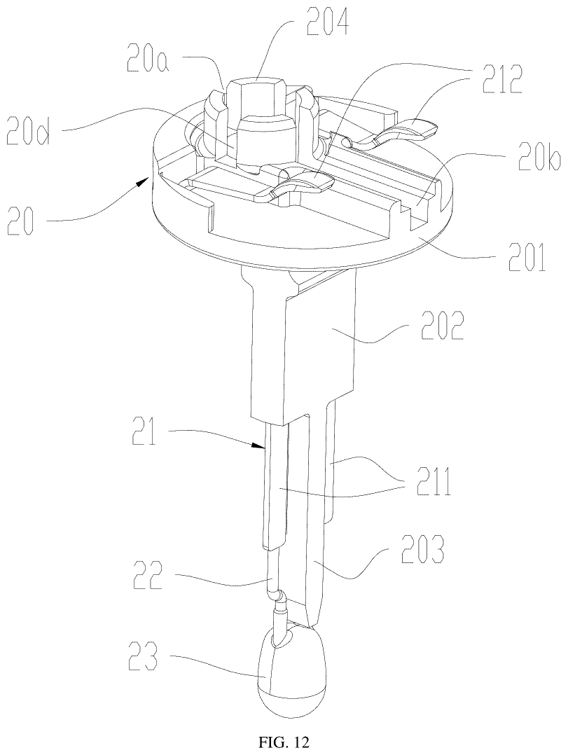

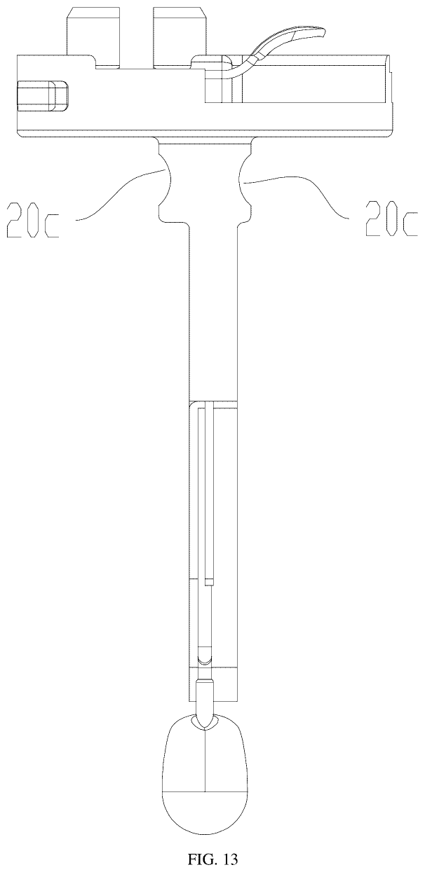

Referring to FIG. 12 and FIG. 13, in other embodiments, the mounting seat 20 may include an extending laterally disk body 201 and a plate body 202. The upper end of the plate body 202 is connected upward to the lower end of the disk body 201. The vertical portions 211 of the two elastic connection bodies 21 are provided at intervals along the width direction of the disk body 201. The lower end of the plate body 202 is fixed with an extension portion 203 longitudinally extended. Two vertical portions 211 are respectively located on opposite sides of the extension portion 203 and laterally approach or abutted against the extension portion 203. In an embodiment, the extension portion 203 is configured to approach or abut downward against the temperature sensor 23. The two connection ends 22 are respectively located on opposite sides of the extension portion 203 and laterally approach or abut against the extension portion 203.

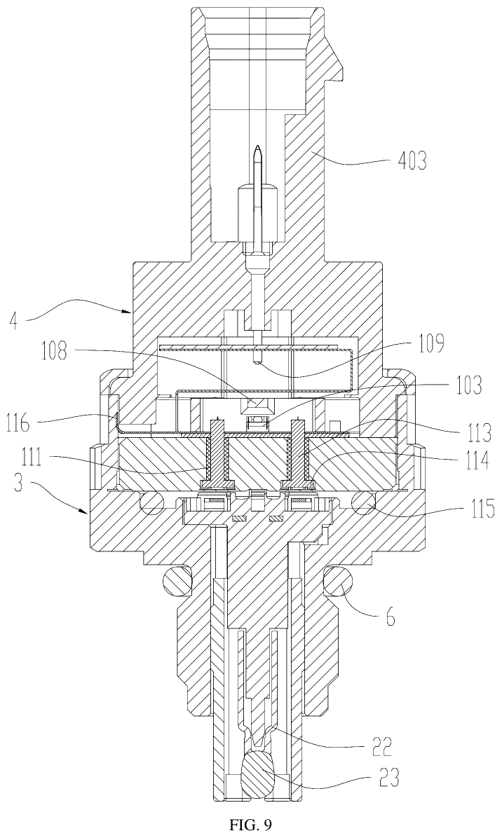

In this way, the extension portion 203 can be inserted between the temperature sensor 23 and the two connection ends 22 as shown in FIG. 9, and can be abutted against or approach the temperature sensor 23 and the two connection ends 22, thereby forming support for the temperature sensor 23 and the connection end 22, and reducing the deformation of the temperature sensor 23.

In some embodiments, a protective sleeve 7 can be fixed in the fluid inlet 30. One end of the mounting seat 20 close to the fluid inlet 30 is configured to extend into the protective sleeve 7. A pressure introduction gap communicated with the lower cavity 01a is left between the inner wall of the fluid inlet 30, the protective sleeve 7 and the mounting seat 20. The pressure introduction gap may include a first pressure introduction gap 03a and/or a second pressure introduction gap 04a. The first pressure introduction gap 03a is surrounded by the protective sleeve 7 and the fluid inlet 30, and the second pressure introduction gap 04a is surrounded by the protective sleeve 7 and the mounting seat 20.

In some embodiments, the lower end of the protective sleeve 7 may be provided with a plurality of third notches 70a laterally opposite to the temperature sensor 23. The lower end of the protective sleeve 7 may extend downward out of the fluid inlet 30. In this way, the fluid inlet 30 can be connected to the pipeline containing the medium under test, so that the temperature sensor 23 is exposed to the medium under test under the protection of the protective sleeve 7. While effectively measuring the temperature of the medium under test, it can avoid becoming ineffective caused by the collision with some foreign particles in the high-flow medium under test.

In order to guide the medium under test to the pressure core 103 more effectively, in other embodiments, a plurality of fourth notches 70b are provided at the upper end of the protective sleeve 7. The inner wall of the fluid inlet 30, the fourth notch 70b and the mounting seat 20 are enclosed to form a transition space 70d. A longitudinal through hole 20d is opened on the mounting seat 20. One end of the longitudinal through hole 20d is directly opposite to and communicated with the transition space 70d. The periphery of the longitudinal through hole 20d is configured to protrude towards one side away from the fluid inlet 30 to form a surrounding wall 204. A corresponding avoidance blind hole 10b may be provided on the ceramic plate 101, and the surrounding wall 204 is configured to extend into the avoidance blind hole 10b to make way for the surrounding wall 204, so as to reduce the overall size of the temperature-pressure sensor; on the other hand, the mounting seat 20 can be positioned with the ceramic plate 101.

A second notch 20a is opened on the surrounding wall 204. A lateral through groove 20b is provided on the mounting seat 20, and one end of the lateral through groove 20b is communicated with the second notch 20a. One side of the lateral through groove 20b away from the fluid inlet 30 is opposite to and is communicated with the hole channel 10d. In this way, the medium under test can be guided to the pressure core 103 through the pressure introduction gap, the transition space 70d, the longitudinal through hole 20d, the lateral through groove 20b, and the hole channel 10d in sequence.

In other embodiments, the two sides of the plate body 202 in the thickness direction are recessed inward to form a laterally extending positioning groove 20c. Two lateral opposite sides of the inner wall of the protective sleeve 7 are configured to protrude outward to form a positioning convex ridge 70c and correspondingly press into the two positioning grooves 20c. In this way, the protective sleeve 7 can be accurately positioned with the temperature sensitive component 2.

In other embodiments, the shell may specifically include a first shell 3 and a second shell 4 longitudinally abutted against the first shell 3 and provided on one side of the first shell 3 away from the fluid inlet 30. A second positioning step 402 is provided at the upper end of the second shell 4. One end of the first shell 3 away from the fluid inlet 30 is configured to extend laterally inward to form a holding and pressing portion 302. The holding and pressing portion 302 is pressed downward on the step surface of the second positioning step 402.

In order to circumferentially position the ceramic plate 101 and the second shell 4, a plurality of positioning concave portions 10a longitudinally penetrated are provided at intervals on the periphery of the ceramic plate 101. The periphery of one end of the second shell 4 close to the fluid inlet 30 is configured to protrude toward one side of the fluid inlet 30 to form a plurality of first positioning convex portions 40a. Each of the first positioning convex portions 40a is configured to extend into one of the positioning concave portions 10a towards one side of the fluid inlet 30.

In order to circumferentially position the ceramic plate 101 and the first shell 3, the inner wall of the first shell 3 is configured to protrude inward to form a plurality of second positioning convex portions 30b. The thickness direction of the ceramic plate 101 is in the longitudinal direction and the thickness of the ceramic plate 101 is greater than the longitudinal length of the first positioning convex portion 40a. The second positioning convex portion 30b is configured to extend into one of the positioning concave portions 10a towards the far side.

In other embodiments, a stopping surface 301 towards one side of the second shell 4 is formed on the inner wall of the first shell 3. A first positioning step 401 is formed on one side of the second shell 4 towards the first shell 3. The first shell 3 and the first positioning step 401 are respectively abutted against the ceramic plate 101 on both sides in the longitudinal direction. A first sealing groove 30a is provided on the stopping surface 301. A first sealing ring 5 is provided in the first sealing groove 30a. In other embodiments, a second sealing groove 30c may be provided on the outer wall of the second shell 4, and a second sealing ring 6 is provided in the second sealing groove 30c.

In other embodiments, the circuit board 104 is a flexible circuit board. As shown in FIG. 1, the circuit board 104 may include a first plate body 117, a second plate body 118 formed by vertically bending a lateral end of the first plate body 117 toward a side away from the fluid inlet 30, a third plate body 119 formed by vertically bending an end of the second plate body 118 away from the first plate body 117 toward the other lateral end of the first plate body, a fourth plate body 120 formed by vertically bending the other end of the third plate body 119 away from the second plate body 118 toward a side away from the first plate body 117, and a fifth plate body 121 formed by vertically bending an end of the fourth plate body 120 away from the first plate body toward the other lateral end. The first plate body 117 is fixed on the end face of the ceramic plate 101 away from the fluid inlet 30. The first plate body 117 is provided with a mounting window 10c for the pressure core 103 to pass longitudinally.

The lateral end of the first plate body 117 can extend laterally outward to form a lateral extension portion 115. The lateral extension portion 115 is configured to pass through the first notch 40c provided on the second shell 4 and bend vertically upward to form a longitudinal extension portion 116. The longitudinal extension portion 116 is abutted against the first shell 3, for example, the longitudinal extension portion 116 can be clamped inside and outside by both the second shell 4 and the first shell 3. The first shell 3 can be made of a conductive material, so that the circuit board 104 can be connected to the ground, thereby releasing static electricity.

In some embodiments of the present application, the conductive pin 110 may include a rod portion 113 longitudinally extended and a cap portion 114 formed by expanding one end of the rod portion 113 close to the fluid inlet 30. The cap portion 114 is abutted against the ceramic plate 101 toward the side away from the fluid inlet 30. The end of the rod portion 113 away from the cap portion 114 is electrically connected to the first plate body 117 of the circuit board 104 through the conductor 106. A conditioning chip 112 and an analog-digital conversion module (not shown) are also provided on the first plate body 117. The bridge circuit on the pressure core 103 is configured to sense the pressure of the medium under test to form a current signal or a voltage signal, which is converted into a digital signal by the analog-digital conversion module, conditioned by the conditioning chip 112, and the measurement result is output to the outside through the pin 109.

In some embodiments of the present application, a frame 107 longitudinally extended is fixed on the upper end surface of the first plate body 117. The upper end of the conductive pin 110 and the pressure core 103 are provided in the frame 107. The frame 107 is filled with a sealant such as silicone to protect the pressure core 103. The third plate body 119 is configured to cover the frame 107 from the upper side of the frame 107.

In some embodiments of the present application, a plug-in connector 403 for electrical connection is integrally connected to the end of the second shell 4 away from the first shell 3. A pressure guiding hole 40b for introducing a reference pressure medium into the lower cavity 01a is provided on the second shell 4, and the pressure guiding hole 40b can be communicated with the atmosphere when a gauge pressure is required. The pressure guiding hole 40b is configured to extend longitudinally and one end of the pressure guiding hole 40b away from the lower cavity 01a is configured to extend into the plug-in connector 403. One end of the pin 109 is electrically connected to the circuit board 104, and the other end of the pin 109 is configured to pass through the second shell 4 in a sealed manner and extend into the plug-in connector 403.

In other embodiments, a first reinforcement plate 102 is fixed between the first plate body 117 and the ceramic plate 101, and a second reinforcement plate 105 is fixedly mounted on the end surface of the fifth plate body 121 away from the first plate body 117.

In other embodiments, a cover beam 108 is parallel to the joining line between the first plate body 117 and the second plate body 118, and two ends of the cover beam 108 are respectively fixed on the frame 107. The cover beam 108 is laterally located between the second plate body 118 and the fourth plate body 120. The pressure core 103 is upward and opposite to the cover beam 108. In this way, the pressure core 103 can be more effectively protected by the cover beam 108, for example, the measurement deviation caused by the compression of the sealant when the first plate body 117 is deformed can be avoided.

The scope of the present application is defined not by the detailed description but by the claims and their equivalents, and all variations within the scope of the claims and their equivalents are construed as being included in the present application.

What is claimed is:

1. A temperature-pressure sensor, comprising:
a shell provided with a fluid inlet;
a pressure sensitive component provided in the shell and comprising: a ceramic plate laterally extended and configured to separate an inner cavity of the shell into an upper cavity and a lower cavity longitudinally opposite to the upper cavity, a pressure core provided in the upper cavity and fixed on the ceramic plate, and a circuit board provided in the upper cavity and fixed on the ceramic plate; wherein the ceramic plate is provided with a hole channel communicated with the upper cavity and the lower cavity, and a pressure sensing surface of the pressure core is configured to seal a corresponding end of the hole channel; and
a temperature sensitive component provided in the lower cavity and comprising a temperature sensor, wherein two connection ends of the temperature sensor are respectively electrically connected to the circuit board through an elastic connection body, a conductive pin and a conductor; the conductive pin is respectively correspondingly penetrated through two via holes opened on the ceramic plate, and a gap between the conductive pin and the corresponding via hole is sealed by a seal body made of glass material; and the fluid inlet is communicated with the lower cavity.

2. The temperature-pressure sensor according to claim 1, wherein the temperature sensitive component further comprises a mounting seat made of insulating material, and a middle part of the elastic connection body is embedded in the mounting seat;
one end of the elastic connection body away from the fluid inlet is configured to extend approximately laterally to form an abutting portion abutted against the conductive pin; and
one end of the elastic connection body towards the fluid inlet is formed with a vertical portion, and the vertical portion is fixed and electrically connected to a corresponding connection end.

3. The temperature-pressure sensor according to claim 2, wherein the mounting seat comprises a disk body laterally extended and a plate body, and one end of the plate body away from the fluid inlet is connected to the disk body; and
two vertical portions of the elastic connection body are provided at intervals along a width direction of the disk body, an extension portion longitudinally extended is fixed to one end of the plate body close to the fluid inlet, and the two vertical portions are respectively provided on opposite sides of the extension portion and configured to laterally approach or abut against the extension portion.

4. The temperature-pressure sensor according to claim 3, wherein the extension portion is configured to approach or abut against the temperature sensor towards one side of the fluid inlet, and the two connection ends are respectively provided on opposite sides of the extension portion and configured to laterally approach or abut against the extension portion.

5. The temperature-pressure sensor according to claim 3, wherein a protective sleeve is fixed in the fluid inlet, one end of the mounting seat close to the fluid inlet is configured to extend into the protective sleeve, and a pressure introduction gap communicated with the lower cavity is left among an inner wall of the fluid inlet, the protective sleeve and the mounting seat; and
the pressure introduction gap comprises: a first pressure introduction gap between the protective sleeve and the fluid inlet, and/or a second pressure introduction gap between the protective sleeve and the mounting seat.

6. The temperature-pressure sensor according to claim 5, wherein two sides of the plate body in a thickness direction are recessed inward to form a positioning groove laterally extended, and lateral opposite sides of an inner wall of the protective sleeve are configured to protrude outward to form a positioning convex ridge correspondingly abutted against two positioning grooves.

7. The temperature-pressure sensor according to claim 5, wherein the shell comprises a first shell and a second shell longitudinally abutted with the first shell and provided on one side of the first shell away from the fluid inlet;
a second positioning step is provided on one side of the second shell away from the fluid inlet;
one end of the first shell away from the fluid inlet is configured to extend laterally inward to form a holding and pressing portion; and
one side of the holding and pressing portion towards the fluid inlet is held and pressed on a step surface of the second positioning step.

8. The temperature-pressure sensor according to claim 7, wherein a plurality of positioning concave portions longitudinally penetrated are provided at intervals on a periphery of the ceramic plate, a periphery of one end of the second shell close to the fluid inlet is configured to protrude towards one side of the fluid inlet to form a plurality of first positioning convex portions, and each of the first positioning convex portions is configured to protrude into one of the positioning concave portions towards one side of the fluid inlet.

9. The temperature-pressure sensor according to claim 8, wherein an inner wall of the first shell is configured to protrude inward to form a plurality of second positioning convex portions; and
a thickness direction of the ceramic plate is in a longitudinal direction, a thickness of the ceramic plate is greater than a longitudinal length of the first positioning convex portion, and the second positioning convex portion is configured to extend into one of the positioning concave portions away from the fluid inlet.

10. The temperature-pressure sensor according to claim 9, wherein a stopping surface is formed on the inner wall of the first shell towards the second shell, a first positioning step is formed on one end of the second shell towards the first shell, and the first shell and the first positioning step are respectively abutted against the ceramic plate on both longitudinal sides; and
a first sealing groove is provided on the stopping surface, and a first sealing ring is provided in the first sealing groove.

11. The temperature-pressure sensor according to claim 7, wherein a plug-in connector for electrical connection is integrally connected to one end of the second shell away from the first shell;
a pressure guiding hole for introducing a reference pressure medium into the lower cavity is provided on the second shell, the pressure guiding hole is configured to extend longitudinally, and one end of the pressure guiding hole away from the lower cavity is configured to extend into the plug-in connector; and
one end of the pin is electrically connected to the circuit board, and another end of the pin is configured to sealingly pass through the second shell and extend into the plug-in connector.

12. The temperature-pressure sensor according to claim 1, wherein the circuit board comprises a first plate body, a second plate body formed by vertically bending a lateral end of the first plate body towards a side away from the fluid inlet, a third plate body formed by vertically bending an end of the second plate body away from the first plate body towards another lateral end of the first plate body, a fourth plate body formed by vertically bending another end of the third plate body away from the second plate body towards a side away from the first plate body, and a fifth plate body formed by vertically bending an end of the fourth plate body away from the first plate body towards the other lateral end of the first plate body; and
the first plate body is fixed to an end face of the ceramic plate away from the fluid inlet, and the first plate body is opened with a mounting window for the pressure core to pass longitudinally.

13. The temperature-pressure sensor according to claim 12, wherein a lateral end of the first plate body is configured to extend laterally outward to form a lateral extension portion, and the lateral extension portion is configured to pass through the shell and vertically bend towards one side away from the fluid inlet to form a longitudinal extension portion.

14. The temperature-pressure sensor according to claim 12, wherein the conductive pin comprises a rod portion longitudinally extended and a cap portion formed by enlarging one end of the rod portion close to the fluid inlet, one side of the cap portion away from the fluid inlet is abutted against the ceramic plate, and an end of the rod portion away from the cap portion is electrically connected to the circuit board through the conductor.

15. The temperature-pressure sensor according to claim 12, wherein a frame longitudinally extended is fixed to an end face of the first plate body away from the fluid inlet, an end of the conductive pin away from the fluid inlet and the pressure core are provided in the frame, and the frame is filled with sealant; and
the third plate body is configured to cover the frame from one side of the frame away from the fluid inlet.
